(19) United States
(12) Patent Application Publication
(10) Pub. No.: US 2006/0245193 A1
(43) Pub. Date: Nov. 2, 2006

(54) Method for manufacturing a vehicular lamp and a vehicular lamp

(75) Inventor: Mitsuyuki Mochizuki, Shizuoka-shi (JP)

Correspondence Address: KODA & ANDROLIA, 2029 CENTURY PARK EAST, SUITE 1140, LOS ANGELES, CA, 90067, US

(73) Assignee: Koito Manufacturing Co., Ltd.

(21) Appl. No.: 11/405,988

(22) Filed: Apr. 18, 2006

(30) Foreign Application Priority Data
Apr. 19, 2005 (JP) 2005-121171

(51) Int. Cl. F21V 33/00

(52) U.S. Cl. 362/253

(57) ABSTRACT

A vehicular lamp 1 hving a front lens 3 provided with a wire 6 for heating the front lens being manufactured by a shape-forming step where a resin sheet 7 is formed into a predetermined shape that corresponds to the shape of an inner surface of the front lens, a wire-installation step where a heating wire is installed by heat to the resin sheet, and a lens-formation step where the front lens is formed by injection molding with the resin sheet set in a molding die 200. The vehicular lamp 1 thus manufactuerd is formed by the front lens and the pre-formed and wire installed resin shett integrated into a single body with the heating wire inbetween.

### BACKGROUND OF THE INVENTION

1. Field of the Invention

The present invention relates to a vehicular lamp manufacturing method and to a vehicular lamp manufactured by the method and more particularly to a method for manufacturing a vehicular lamp that has a heating wire therein and to such a vehicular lamp.

2. Description of the Related Art

In some vehicular lamps, a wire is installed in the front lens so that the wire is electrically heated for the purpose of defrosting the front lens and melting snow on the front lens.

However, since the front lenses of vehicular lamps are generally formed in a shape conforming to the exterior contour of a vehicle body, at least a portion of the front lens inevitably has a curved surface, and as a result, it is difficult to install a wire, which functions as a heater, at a desired position of the front lens, and there always is a risk that the wire is separated from the front lens or short-circuiting occurs in the wire.

### BRIEF SUMMARY OF THE INVENTION

Accordingly, it is an object of the present invention to provide a method for manufacturing a vehicular lamp and to provide a vehicular lamp that is free of occurrence of wire separation or short-circuiting.

The above object is accomplished by unique steps of the present invention for a method for manufacturing a vehicular lamp; and in the present invention, the method comprises a shape-forming step that forms a resin sheet into a predetermined shape that corresponds to the shape of the inner surface of a front lens, a wire installation step that installs a wire (or a heating wire) by heat in the resin sheet, and a lens-formation step that injection-molds the front lens with the resin sheet set in a molding die.

The above ojbect is further accomplished by a unique structure of the prsent inveniton for a vehicular lamp in which a resin sheet is integrally fixed to a front lens of the lamp, and this resin sheet is in a predetermined shape that corresponds to the shape of the inner surface of the front lens and a wire (heating wire) is installed therein by heat.

As seen from the above, in the vehicular lamp manufacturing method and vehicular lamp of the present invention, wiring of heating wire or the installation of heating wire is performed after the shape of the resin sheet is established.

More specifically, in the vehicular lamp manufacturing method of the present invention, a resin sheet is formed into a predetermined shape that is substantially rigid and corresponds to the shape of the inner surface of a front lens in the shape-forming step, a heating wire is next installed by heat in the resin sheet in the wire-installation step; and then the front lens is injection-molded in a molding die with the resin sheet provided with the heating wire set therein in the lens-formation step.

Accordingly, in the present invention, it is possible to install the heating wire at a desired position of the front lens without the occurrence of heating wire separation or short-circuiting in the heating wire.

In the present invention, ultrasonic wire installation can be employed for installing the heating wire in the resin sheet. More specifically, in the present invention, the resin sheet is subjected to ultrasonic vibration so as to be heated and melted, thus allowing at least a portion of the heating wire to be embedded in the resin sheet. With the use of ultrasonic wire installation, the apparatus for thermally installing the heating wire in the resin sheet can be simple in structure and the operation time of such apparatus can be shortened.

Furthermore, in the present invention, the heating wire is installed so that it comprises a plurality of vertical wire portions that extend in the vertical direction of the resin sheet and a plurality of connecting portions that connect respective ends of adjacent vertical wire portions, and the length of (each one of) the vertical wire portions is set to be longer than the length of (each one of) the connecting portions. With this arrangement, light of the lamp is much less apt to diffuse vertically, and it is thus possibled to reduce the generation of glare light.

In addition, in the present invention, the resin sheet is set in a molding die so that the wire-installation surface of the resin sheet, on which the heating wire is installed, faces the resin injected into the molding die. Accordingly, it is possible to manufacture a vehicular lamp having an improved appearance.

The vehicular lamp of the present invention is a vehicular lamp in which a front lens is provided with a wire that heats up the front lens, and in the present invention, a resin sheet is integrally fixed to the front lens, and this resin sheet is formed in a predetermined shape that corresponds to the shape of the inner surface of the front lens and is theremally provided with a wire (heating wire).

Accordingly, in the vehicular lamp of the present invention, it is possible to install the heating wire at a desired position of the front lens without the occurrence of wire separation or wire short-circuiting.

### BRIEF DESCRIPTION OF THE SEVERAL VIEWS OF THE DRAWINGS

FIG. 1 is a cross-sectional view of the vehicular lamp according to the present invention;

FIG. 2 is a front elevational view of the vehicular lamp;

FIG. 3 is a conceptual diagram of a resin sheet used in the vehicular lamp of the present invention;

FIGS. 4A through 4C show the procedure of installing the wire (heating wire) in the resin sheet by heat, wherein FIG. 4A shows a standby state prior to the installation of the wire, FIG. 4B shows the wire installation state, and FIG. 4C shows the state that the wire installation is completed;

FIG. 5 is an enlarged cross-sectional view of the wire partially embedded in the resin sheet by heat;

FIG. 6 is a cross-sectional view of the molding die with the resin sheet set inside;

FIG. 7A, a combination of the front elevational view and the cross-sectional view, shows the appearance of the resin sheet with the wire installed, and 7B, a combination of the front elevational view and the cross-sectional view, shows the appearance of the front lens with the wire-installed resin sheet fixed thereto; and

FIG. 8A shows light distribution characteristics of the light emitted from a light source of the vehicular lamp of the present invention in which the wire is vertically arranged, and FIG. 8B shows light distribution characteristics of the light emitted from a light source of a vehicular lamp in which the wire is horizontally arranged.

### DETAILED DESCRIPTION OF THE INVENTION

The preferred embodiments of the vehicular lamp manufacturing method and of the vehicular lamp according to the present invention will be described below with reference to the accompanying drawings.

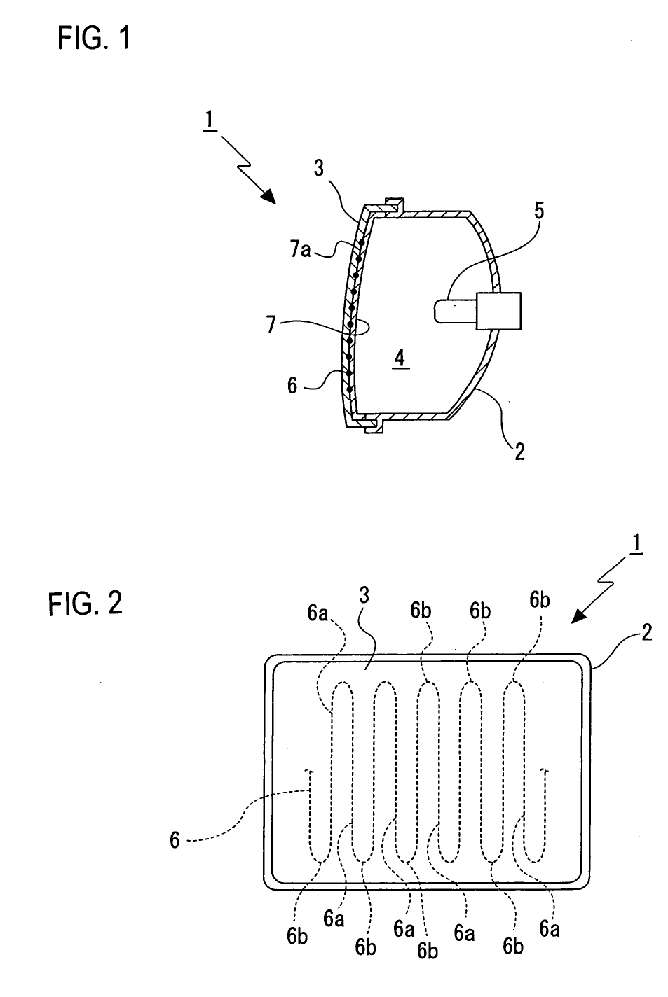

FIGS. 1 and 2 schematically show an example of the vehicular lamp manufactured by the vehicular lamp manufacturing method of the present invention.

The vehicular lamp 1 is, for example, a front lamp for an automobile, and it includes a lamp body 2 with its concave portion open in the front, and a front lens 3 that closes the front opening of the lamp body 2. The internal space defined by the lamp body 2 and the front lens 3 makes a lamp chamber 4. Attached to the lamp body 2 is a light source bulb 5 that is disposed inside the lamp chamber 4. The light source bulb 5 is, for example, a discharge bulb, but a light source other than the discharge bulb including an incandescent bulb such as a halogen bulb, or a light-emitting diode and the like can be used.

A wire (heating wire) 6 such as a copper wire that can be electrically heated is embedded in and fixed to the front lens 3. As shown in FIG. 2, the wire 6 comprises a plurality of vertical wire portions 6a that extend in the vertical direction (an up-down direction) of the front lens 3 and a plurality of connecting portions 6b that connect the respective ends of adjacent vertical wire portions 6a. The length of (each one of) the vertical wire portions 6a is set longer than the length of (each one of) the connecting portions 6b.

The diameter of the wire 6 is preferably 0.05 mm to 0.2 mm. If the wire diameter is too small (or smaller than 0.05 mm), the risk of short-circuiting increases. If the wire diameter is too large (or larger than 0.2 mm), then light rays passing through the front lens 3 may be blocked, adversely affecting the light distribution of the lamp 1 and making the wire 6 conspicuous, worsening the appearance of the front lens 3.

The space between adjacent vertical wire portions 6a of the wire 6 may be in the range from 5 mm to 25 mm. If the space between the vertical wire portions 6a is too small, light distribution is greatly affected; and if the wire space is too large, then a desired heat amount is not obtainable.

In the vehicular lamp 1 as described above, when the electric current flows in the wire 6 installed in the front lens 3, the wire 6 is heated, increasing the temperature for the portion of the front lens 3 where the wire 6 is provided. As a result, the generated heat melts snow on the surface of the front lens 3 and defrosts the inside and outside of the front lens 3.

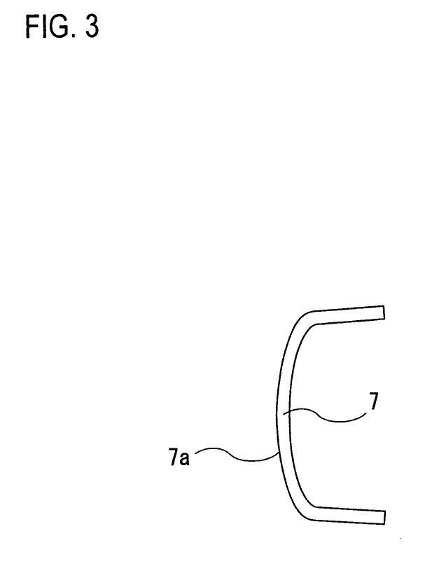

Next, the method for installing the wire 6 to the inner surface of the front lens 3 and a method for fixing the installed wire 6 to the front lens 3 will be described with reference to FIGS. 3 to 6.

A resin sheet 7 is first pre-formed so that it has a predetermined shape that corresponds to the shape of the inner surface of the front lens 3 (a shape-forming step). Material similar to that of the front lens 3 can be used for the resin sheet 7, such as polycarbonate, acrylic resin, etc. The pre-forming of the resin sheet 7 is performed by a so-called thermoforming, which involves heating and softening of a resin sheet body, and subsequently pressing the resin sheet body into a die by vacuum suction or pneumatic pressure, then compressing the resin sheet body between two dies. A flat resin sheet body, for example, is thus formed into a curved shape by thermoforming to make the resin sheet 7 that is substantially rigid (see FIG. 3).

Next, the wire 6 is installed by heat or thermally installed in the resin sheet 7 (a wire-installation step). The thermal installation is an operation where heat is applied to a substrate (the resin sheet 7 in the present invention), on which the wire 6 is installed, so as to heat and soften the substrate (the resin sheet 7), after which the wire 6 is pressed into heated and softened locations of the substrate such that the wire 6 is as least partially embedded in the substrate (the resin sheet 7). Means for heating the substrate include, for example, applying the ultrasonic vibration to the substrate or pressing a heated pressing member against the substrate.

Wire installation by heat or thermal wire installation is performed using, for example, a wire installation head as described in Japanese Patent No. 3190345.

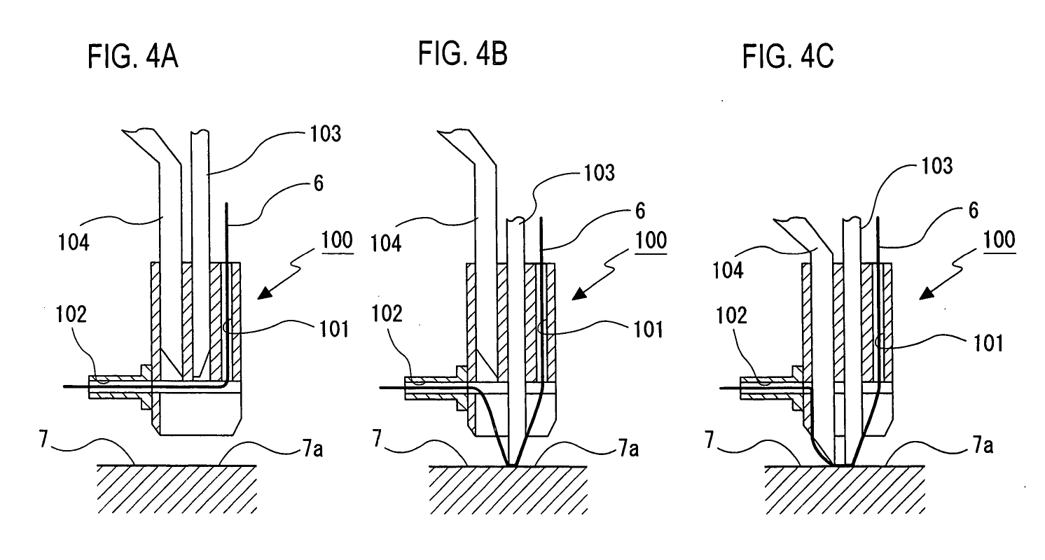

In the standby state as shown in FIG. 4A, the wire 6 is first inserted into the guide portions 101 and 102 of a wire installation head 100 so that the wire 6 is inside a generally L-shaped route.

In the next step, as shown in FIG. 4B, a pressing arm 103 is projected out. Upon projection of the pressing arm 103, the wire 6 is pushed by the tip end of the pressing arm 103 and pushed out of the guide portion 102, and the wire 6 is pressed onto the wire-installation surface 7a of the resin sheet 7 by the tip end of the pressing arm 103.

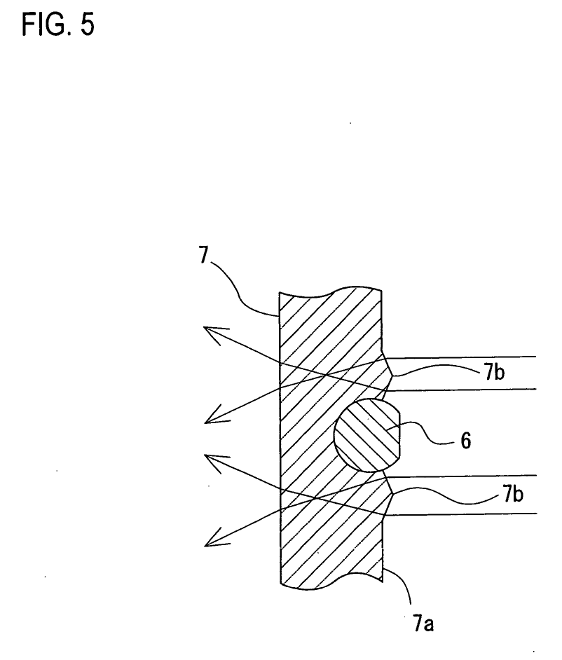

Next, the tip portion of the pressing arm 103 is heated, or an ultrasonic vibration is applied to the pressing arm 103. Once the tip portion of the pressing arm 103 is heated, or ultrasonic vibration is applied to the pressing arm 103, the portion of the resin sheet 7 with the wire 6 being pressed thereon is heated and softened. As a result, with a predetermined pressure applied to the pressing arm 103 toward the resin sheet 7, the wire 6 is pressed by the pressing arm 103 and is subsequently softened by the heating and pushed into the resin sheet 7 (see FIG. 5).

As seen from the above, the pressing arm 103 is heated or subjected to ultrasonic vibration; and in this state, the predetermined pressure is applied toward the resin sheet 7, and the wire installation head 100 is moved along a predetermined route. As a result, the wire 6 is embedded in the resin sheet 7 at a predetermined position and in a predetermined pattern.

When the wire installation head 100 is moved to a wire installation termination position, a tip end of the cutter 104 projects out as shown in FIG. 4C and cuts the wire 6.

In the above-described wire installation process, the wire 6 is embedded in the resin sheet 7 except its two end portions, and the two end portions of the wire 6 not embedded are raised from the resin sheet 7 and, as described below, are connected to terminals (not shown).

Following the completion of the installation of the wire 6 by heat in the resin sheet 7, the two end portions of the wire 6 are respectively connected to the terminals that have been fixed in advance to the resin sheet 7. Connection of the end portions of the wire 6 to the terminals is achieved by winding the two end portions of the wire 6 around the respective terminals and fixing them by welding.

As seen from the above, the wire 6 is installed in any desired pattern by way of moving the wire installation head 100 in a predetermined desired path, and the connection of the two end portions of the wire 6 to the respective terminals are made, thus completing the wire installation.

Trimming is next performed on the resin sheet 7 so that the resin sheet 7, in which the wire 6 is embedded or installed, is cut into so as to have a desired exterior contour. A cutting tool such as a cutter is used to perform the resin sheet trimming.

Next, a lens-formation step is performed.

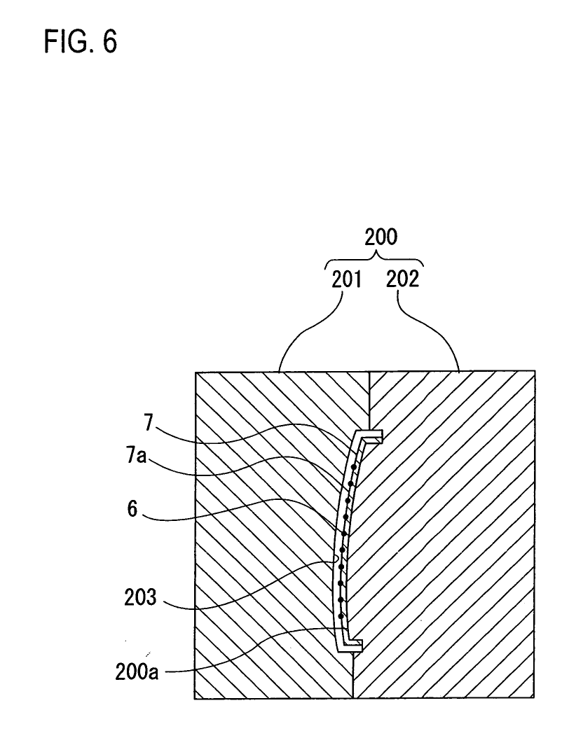

So as to mold the front lens 3, the resin sheet 7 formed as described above and is substantially rigid is first inserted into and set in a molding die 200. As shown in FIG. 6, the molding die 200 is comprised of a fixed die 201 and a movable die 202; and it has a cavity 203 formed by and between the fixed die 201 and the movable die 202. The cavity 203 has the size of the resin sheet 7 after molding and the front lens 3 combined.

The resin sheet 7 is set in the cavity 203 of the molding die 200 such that the wire 6 in the resin sheet 7 will come into contact with the material for the front lens 3 and that the wire-installation surface 7a of the resin sheet 7 in which the wire 6 is installed faces the direction not in contact with the die surface 200a of the movable die 202 (or the wire-installation surface 7a faces opposite from the die surface 200a of the movable die 202).

Following the insertion or setting of the resin sheet 7 inside the molding die 200, a melted resin that serves as the material for the front lens 3 is injected into the cavity 203 to form the front lens 3. The heat of the injected melted resin softens a portion of the wire-installation surface 7a of the resin sheet 7 in contact with the melted resin. Consequently, the wire-installation surface 7a of the resin sheet 7 and a portion of the melted resin in contact with the wire-installation surface 7a attain a mutually melted state, and cooling and hardening of the melted resin bring the front lens 3 and the resin sheet 7 into integration. The front lens 3 integrated with the resin sheet 7 is then extracted from the cavity 203 by releasing the movable die 202 from the fixed die 201.

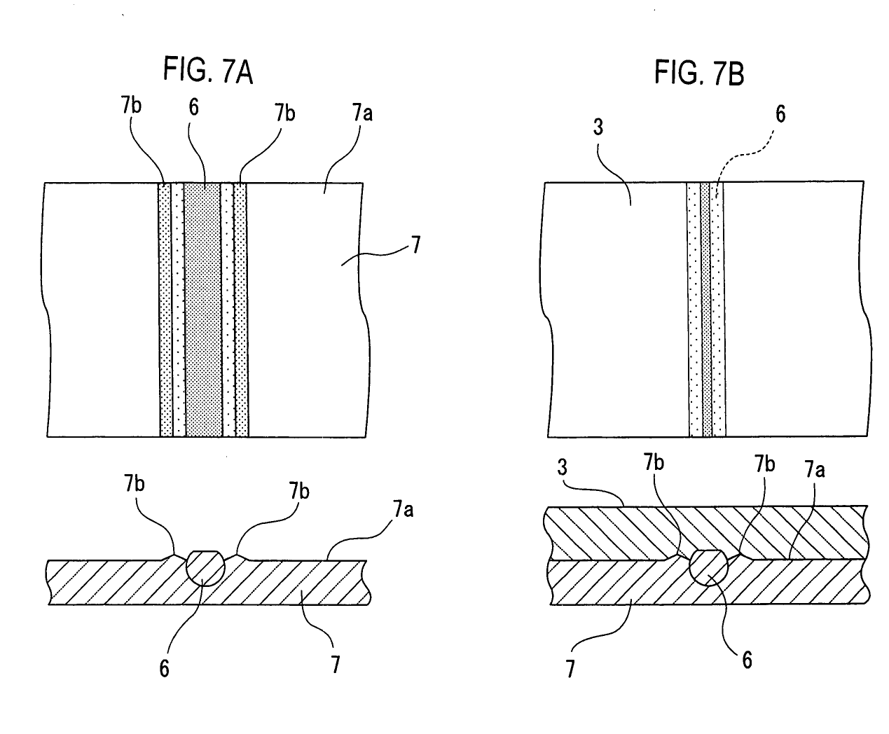

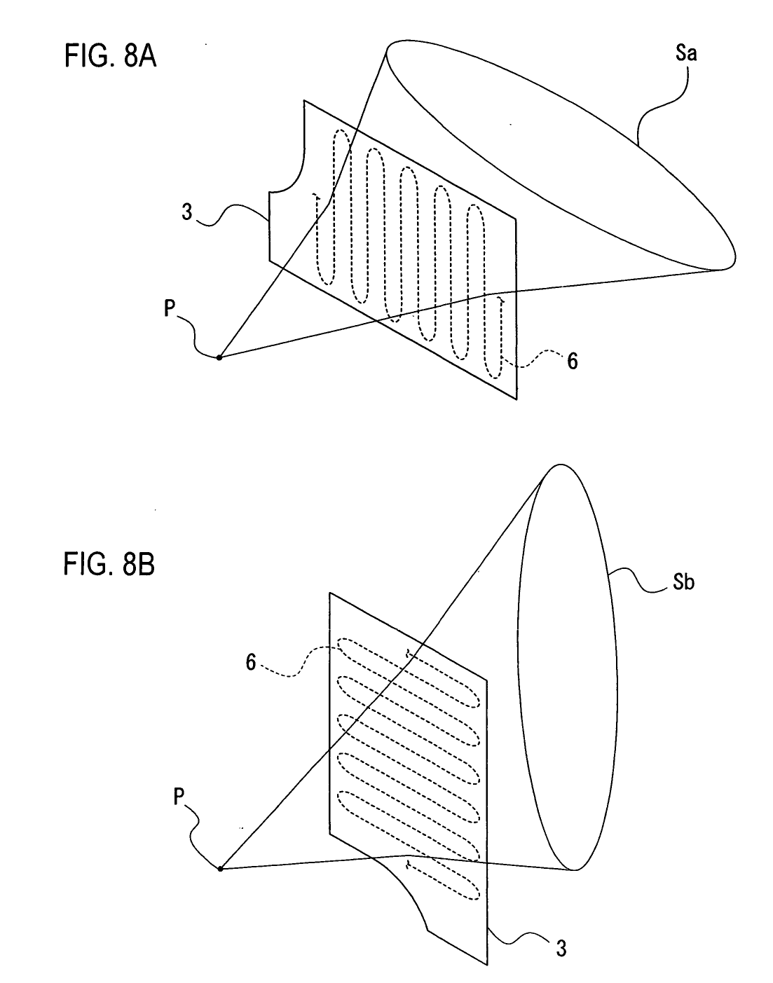

Meanwhile, in the state that the wire 6 is embedded in the resin sheet 7 (or in the wire-installation surface 7a) by heat, the wire 6 is, as seen from FIG. 5, only partially embedded in the resin sheet 7. Moreover, the material for the resin sheet 7, which was pressed during the installation or embedding process of the wire 6, protrudes out in a bank formation along the wire 6, forming bulged bank portions 7b. The distance between the bulged bank portions 7b on both sides of the wire 6 is greater than the diameter of the wire 6; and therefore, the appearance of the resin sheet 7 deteriorates. Furthermore, the bulged bank portions 7b would act as prisms for light rays, causing the light distribution to be disrupted due to diffuse reflection or diffuse refraction occurring at the bulged bank portions 7b and the like (arrows in FIG. 5 represent paths of the light rays incident to the bulged bank portions 7b). Accordingly, in the state that the wire 6 is embedded in the resin sheet 7, the bulged bank portions 7b become conspicuous as shown in FIG. 7A, worsening the appearance of the vehicular lamp 1.

However, in the vehicular lamp 1 of the present invention, the front lens 3 and the resin sheet 7 are integrated with the wire-installation surface 7a of the resin sheet 7 facing the front lens 3 (see FIG. 1). Accordingly, diffuse reflection and diffuse refraction caused by the bulged bank portions 7b is reduced as shown in FIG. 7B. Consequently, as seen from FIG. 7B, only the wire 6 stands out when viewing the vehicular lamp 1 from the front lens 3 side (or from the front of the front lens 3), and the bulged bank portions 7b no longer call attention to their presence. The vehicular lamp 1 thus has an improved appearance.

Furthermore, since the front lens 3 and the resin sheet 7 are integrated with the wire-installation surface 7a of the resin sheet 7 facing the front lens 3, separation of the wire 6 from the front lens 3 is prevented. In addition, since the wire 6 is not exposed to air, it is possible to prevent changes in its resistance value, discoloration, and deterioration due to the oxidation, etc. of the wire 6.

Lastly, the front lens 3 manufactured as described above is mounted in the lamp body 2, and the terminals connected to the wire 6 are connected to a power source via connectors (not shown) so that the wire 6 is brought into a state capable of being supplied with electricity.

As seen from the above, in the vehicular lamp 1 of the present invention, the resin sheet 7 is formed in a predetermined shape that corresponds to the shape of the inner surface of the front lens 3, the wire 6 is installed in the resin sheet 7 by heat, and then the resin sheet 7 and the front lens 3 are integrated.

The wire 6 can be installed by heat to a flat resin sheet prior to its formation into a predetermined shape (such as the one shown in FIG. 3), and then the resin sheet is formed into a predetermined shape that corresponds to the shape of the inner surface of the front lens 3. However, with such steps that are inverse to the steps of the present invention, there is a risk that the wire 6 installed by heat is separated from the resin sheet or that short-circuit occurs when the resin sheet is formed into a predetermined shape.

In the present invention as seen from the above, the wire 6 is thermally installed after the resin sheet 7 is formed into a predetermined shape that corresponds to the shape of the inner surface of the front lens 3; accordingly, it is ensured that is no separation or short-circuiting of the wire 6 would occur. Moreover, it is possible in the present invention to arrange and fix the wire 6 that functions as a heater at a desired position of the front lens 3 in a desired pattern.

Furthermore, in the present invention, ultrasonic wire installation is employed for installing the wire 6 by heat, wherein the resin sheet 7 is subjected to ultrasonic vibration, and thus heated and melted, so that at least a portion of the wire 6 is embedded in the resin sheet 7. This makes the apparatus for thermally installing the wire simpler in structure and the operation time of such apparatus shorter.

In the vehicular lamp 1 of the present invention, the length of the vertical wire portions 6a of the wire 6 is set longer than the length of the connecting portions 6b as described above. Accordingly, as seen from FIG. 8A, diffuse refracted light, which is generated by the bulged bank portions 7b around the wire 6 and is among the light emitted from the light source P and passes through the front lens 3, is diffused horizontally to generate a horizontally oblong-shaped diffuse refracted light distribution Sa.

On the other hand, if the wire 6 is provided so that it comprises mainly portions that extend in the horizontal direction as shown in FIG. 8B, then diffuse refracted light, which is generated by the bulged bank portions 7b around the wire 6 and is among the light emitted from the light source P and passes through the front lens 3, is diffused vertically, generating a vertically oblong-shaped diffuse refracted light distribution Sb. When such a vertically oblong-shaped diffuse refracted light distribution Sb is generated, glare light is more likely to occur to the oncoming vehicles.

As seen from above, with the setting of the length of the vertical wire portions 6a of the wire 6 longer than the length of the connecting portions 6b, light is much less apt to diff-use vertically, thus reducing the generation of glare light.

The shapes and configurations of the respective portions described and shown in the above embodiments are all merely one specific example for carrying out the present invention, and they must not be interpreted to limit the technical scope of the present invention in any manner.

1. A method for manufacturing a vehicular lamp in which a front lens thereof is provided with a wire for heating the front lens, said method comprising the steps of:
forming a resin sheet into a predetermined shape that corresponds to a shape of an inner surface of the front lens;
installing a wire in the resin sheet by heat; and
executing an injection molding for molding a front lens with the resin sheet set in a molding die, thus foring the front lens integrated with the resin sheet.

2. The method for manufacturing a vehicular lamp according to claim 1, wherein
the resin sheet is subjected to ultrasonic vibration so as to be heated and melted, thus allowing at least a portion of the wire is embedded in the resin sheet.

3. The method for manufacturing a vehicular lamp according to claim 1, wherein
the wire installed comprises a plurality of vertical wire portions that extend in a vertical direction of the resin sheet and a plurality of connecting portions that connect respective ends of adjacent vertical wire portions, and
a length of the vertical wire portions is set to be longer than a length of the connecting portions.

4. The method for manufacturing a vehicular lamp according to claim 1, wherein
the resin sheet is set in the molding die such that a wire-installation surface thereof in which the wire is installed faces an injected resin.

5. A vehicular lamp comprising a front lens having a wire for heating the front lens, wherein
the front lens is integrally fixed on an inner surface thereof with a resin sheet, and
the resin sheet is in a predetermined shape that corresponds to a shape of the inner surface of the front lens and is installed therein with the wire by heat.
